(19) United States
(12) Patent Application Publication
(10) Pub. No.: US 2013/0028429 A1
(43) Pub. Date: Jan. 31, 2013

(54) INFORMATION PROCESSING APPARATUS AND METHOD OF PROCESSING AUDIO SIGNAL FOR INFORMATION PROCESSING APPARATUS

(71) Applicants: Tadashi Amada, Ome-shi (JP); Toshifumi YAMAMOTO, Hino-shi (JP); Kimio MISEKI, Ome-shi (JP)

(72) Inventors: Tadashi Amada, Ome-shi (JP); Toshifumi YAMAMOTO, Hino-shi (JP); Kimio MISEKI, Ome-shi (JP)

(73) Assignee: KABUSHIKI KAISHA TOSHIBA, Tokyo (JP)

(21) Appl. No.: 13/462,163

(22) Filed: May 2, 2012

(30) Foreign Application Priority Data
Jul. 29, 2011 (JP) 2011-166782

(51) Int. Cl. H04R 29/00

(52) U.S. Cl. 381/59

(57) ABSTRACT

According to one embodiment, an information processing apparatus includes a measurement module and a correction filter design module. The measurement module measures frequency characteristics of an earphone connected to an output terminal using a measurement audio signal output from the output terminal and collected by a microphone. The correction filter design module designs a correction filter in association with one range of a treble range higher than a crossover frequency range and a bass range lower than the crossover frequency range, based on the measured frequency characteristics of the earphone and predetermined goal frequency characteristics.

### CROSS-REFERENCE TO RELATED APPLICATIONS

This application is based upon and claims the benefit of priority from prior Japanese Patent Application No. 2011-166782, filed Jul. 29, 2011, the entire contents of which are incorporated herein by reference.

### FIELD

Embodiments described herein relate generally to an audio signal processing technique suited to an information processing apparatus including an output terminal which can connect earphones.

### BACKGROUND

In recent years, portable information processing apparatuses, which are called notebook-type PCs (Personal Computers) (to be referred to as note PCs hereinafter), and can be driven using a battery, have prevailed. A large number of information processing apparatuses of this type include an advanced audiovisual (AV) function (which, for example, can output images with high resolutions and can output sound with high sound quality) equivalent to that of desk-top type information processing apparatuses. There are many chances to use such note PC of the advanced function model as a Digital Versatile Disc (DVD) player or music player.

Also, such note PC of the advanced function model includes an audio signal output terminal, which can connect earphones, in addition to loudspeakers. For example, in an environment in which sound cannot be output from the loudspeakers, the user connects earphones to the output terminal, and listens to sound played back by the note PC.

An unspecified number of earphones, which can be used by users, have various characteristics. For this reason, various mechanisms for appropriately correcting the characteristics of such unspecified number of earphones have been proposed.

However, the mechanisms for correcting the characteristics of earphones, which have been proposed so far, may cause an increase in cost, and may force the users to make troublesome operations, thus posing problems.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary view showing the outer appearance of an information processing apparatus according to an embodiment.

FIG. 2 is an exemplary block diagram showing the system arrangement of the information processing apparatus according to the embodiment.

FIG. 3 is an exemplary block diagram showing functional blocks of a media player, which runs on the information processing apparatus according to the embodiment.

FIG. 4 is an exemplary view showing a measurement example of frequency characteristics of an earphone using a jig.

FIG. 5 is an exemplary graph showing the frequency characteristics of the earphone measured in the state shown in FIG. 4.

FIG. 6 is an exemplary view showing a state in which an ear tip of an earphone is in contact with a microphone so that the earphone and microphone are in tight contact with each other, upon measuring the frequency characteristics of the earphone in the information processing apparatus according to the embodiment.

FIG. 7 is an exemplary graph showing the frequency characteristics of the earphone measured in the state shown in FIG. 6.

FIG. 8 is an exemplary view showing a state in which an ear tip of an earphone is in contact with a microphone so that a gap is formed between the earphone and microphone, upon measuring the frequency characteristics of the earphone in the information processing apparatus according to the embodiment.

FIG. 9 is an exemplary graph showing the frequency characteristics of the earphone measured in the state shown in FIG. 8.

FIG. 10 is an exemplary first graph for explaining a predicted equalizer set in a crossover frequency range, so as to allow the information processing apparatus according to the embodiment to correct the frequency characteristics of the earphone more appropriately.

FIG. 11 is an exemplary second graph for explaining a predicted equalizer set in a crossover frequency range, so as to allow the information processing apparatus according to the embodiment to correct the frequency characteristics of the earphone more appropriately.

FIG. 12 is an exemplary flowchart showing the sequence of audio signal processing to be executed by the information processing apparatus according to the embodiment to correct the frequency characteristics of an earphone.

FIG. 13 is an exemplary block diagram for explaining an application example of the audio signal processing to be executed by the information processing apparatus according to the embodiment to correct the frequency characteristics of an earphone.

### DETAILED DESCRIPTION

Various embodiments will be described hereinafter with reference to the accompanying drawings.

In general, according to one embodiment, an information processing apparatus includes an output terminal, a microphone, a measurement module and a correction filter design module. The measurement module is configured to measure frequency characteristics of an earphone connected to the output terminal using a measurement audio signal output from the output terminal and collected by the microphone. The correction filter design module is configured to design a correction filter based on the frequency characteristics of the earphone measured by the measurement module and predetermined goal frequency characteristics. The correction filter is required to correct frequency characteristics of sound output from the earphone to the predetermined goal frequency characteristics in association with one range of a treble range higher than a crossover frequency range and a bass range lower than the crossover frequency range. The crossover frequency range is a frequency range where a bass range is switched to the treble range.

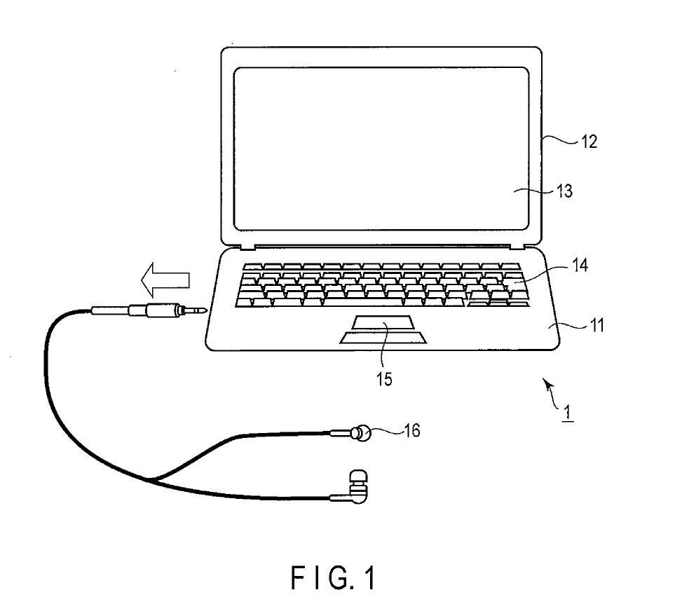

FIG. 1 is an exemplary view showing the outer appearance of an information processing apparatus according to this embodiment with a display unit being opened. This information processing apparatus is implemented as, for example, a portable notebook-type PC 1, which can be driven using a battery.

As shown in FIG. 1, the PC 1 is configured by a computer body 11 and display unit 12. A liquid crystal display (LCD) 13 is built in the display unit 12. The display unit 12 is attached to the computer body 11 to be free to pivot between an open position where the upper surface of the computer body 11 is exposed, and a closed position where the upper surface of the computer body 11 is covered.

The computer body 11 has a low-profile box-shaped housing, and a keyboard 14, touchpad 15, and the like are arranged on its upper surface. The computer body 11 incorporates a microphone, and a microphone aperture is formed in a housing front surface portion, so that the microphone can efficiently collect sound. An audio signal output terminal which can connect an earphone (earphones) 16 is arranged on a housing side surface portion of the computer body 11.

When a measurement audio signal is output to the output terminal (to which the earphone 16 is connected) while the earphone 16 is in contact with the microphone aperture, since this measurement audio signal is collected by the microphone, the characteristics of the earphone 16 can be measured. The information processing apparatus (PC 1) of this embodiment includes a mechanism for correcting the characteristics of the earphone 16, which can be measured in this way, with low cost and by a simple operation, and this point will be described in detail below.

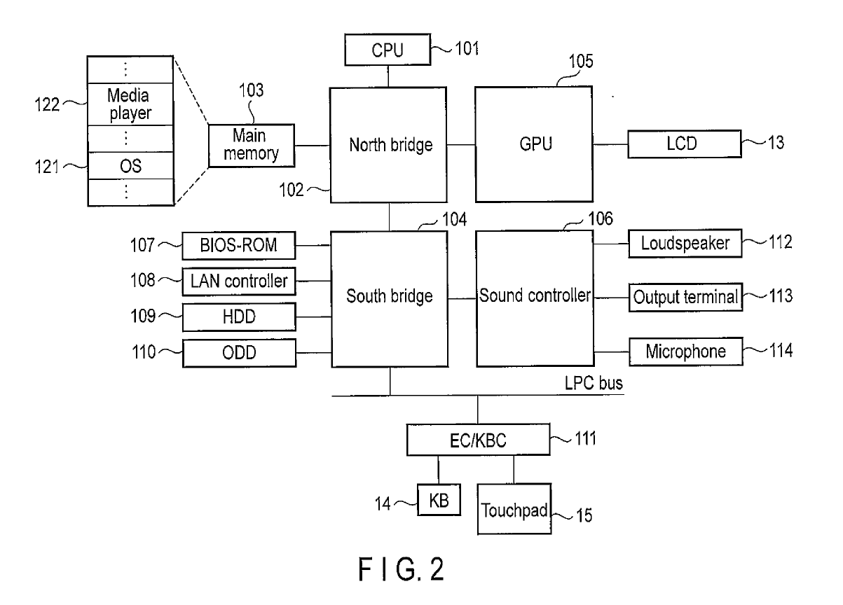

FIG. 2 is an exemplary block diagram showing the system arrangement of the PC 1.

As shown in FIG. 2, the PC 1 includes a central processing unit (CPU) 101, north bridge 102, main memory 103, south bridge 104, and graphics processing unit (GPU) 105. Also, the PC 1 includes a sound controller 106, Basic Input/Output System (BIOS) read-only memory (ROM) 107, local area network (LAN) controller 108, hard disk drive (HDD) 109, optical disc drive (ODD) 110, and embedded controller/keyboard controller (EC/KBC) 111.

The CPU 101 is a processor which controls the operation of the PC 1, and executes various programs loaded from the HDD 109 onto the main memory 103. The programs to be executed by the CPU 101 include an operating system (OS) 121 for resource management, a media player 122 (to be described later), which runs under the OS 121, and the like. The media player 122 is application software used to play back movie (video) and audio files. The CPU 101 also executes a BIOS stored in the BIOS-ROM 107. The BIOS is a program for hardware control.

The north bridge 102 serves as a bridge device which connects between the CPU 101 and south bridge 104, and also as a memory controller for controlling accesses to the main memory 103. Also, the north bridge 102 includes a function of executing communications with the GPU 105.

The GPU 105 is a display controller for executing an image display operation on the LCD 13 built in the display unit 12. Also, the GPU 105 includes an accelerator for rendering images to be displayed by various programs in place of the CPU 101.

The south bridge 104 serves as a memory controller for controlling accesses to the BIOS-ROM 107. Also, the south bridge 104 incorporates an Integrated Device Electronics (IDE) controller required to control the HDD 109 and ODD 110. Furthermore, the south bridge 104 includes a function of executing communications with the sound controller 106.

The sound controller 106 is a sound source device, and includes circuits such as a digital-to-analog converter for converting a digital signal into an electrical signal, an amplifier for amplifying the electrical signal, and the like, so as to output audio data to be played back to a loudspeaker 112 or output terminal 113 (arranged on the housing side surface portion of the aforementioned computer body 11). Also, the sound controller 106 includes circuits such as an analog-to-digital converter for converting an electrical signal input from a microphone 114 (incorporated in the aforementioned computer body 11) into a digital signal, and the like.

The EC/KBC 111 is a single-chip microcomputer which integrates an embedded controller for power management of the PC 1, and a keyboard controller for controlling the keyboard 14 and touchpad 15.

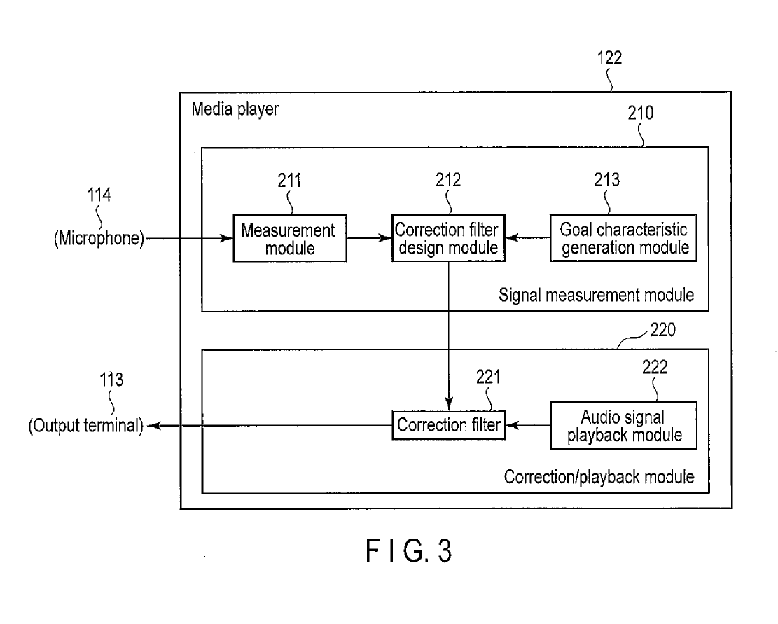

FIG. 3 is an exemplary block diagram showing functional blocks of the media player 122, which runs on the PC 1 having the aforementioned system arrangement.

As shown in FIG. 3, the media player 122 includes a signal measurement module 210 and correction/playback module 220. The signal measurement module 210 includes a measurement module 211, correction filter design module 212, and goal characteristic generation module 213. The correction/playback module 220 includes a correction filter 221 and audio signal playback module 222.

In order to help understanding the mechanism, which is included in the information processing apparatus (PC 1) of this embodiment, and is required to correct the characteristics of an earphone at low cost and by a simple operation, the frequency characteristics of the earphone 16 (connected to the output terminal 113), which are measured by outputting a measurement audio signal from the output terminal 113 and collecting it by the microphone 114, will be described below.

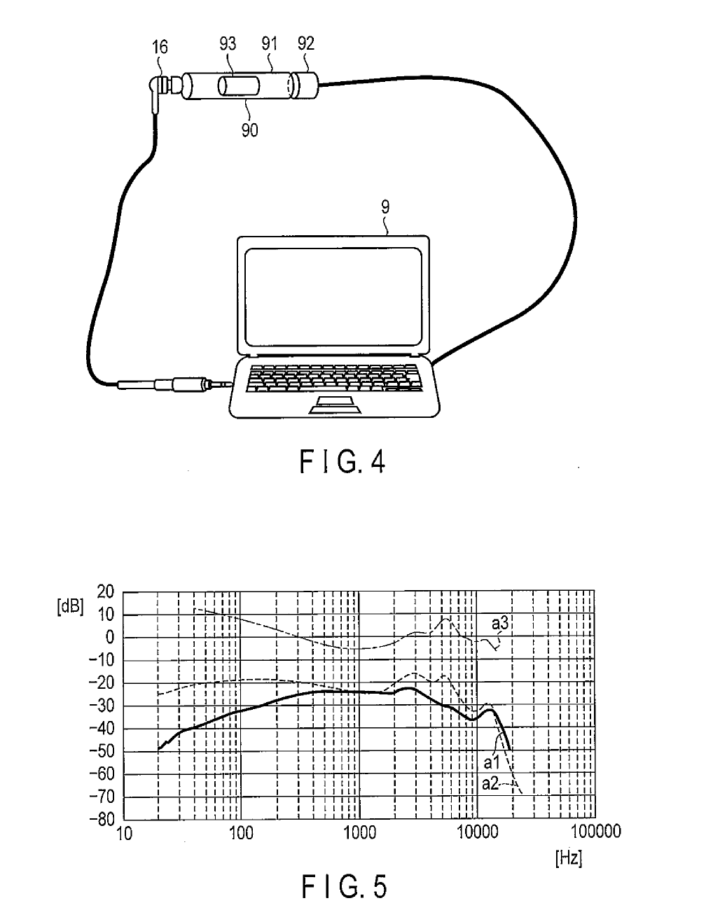

A method of measuring the frequency characteristics of the earphone using a jig, which is available as that of measuring the frequency characteristics of the earphone, will be described first. FIG. 4 is an exemplary view showing a measurement example of the frequency characteristics of the earphone using the jig.

A jig 90 is configured by a tube 91, microphone 92, and sound absorbing member 93. The tube 91 is, for example, a cylindrical member made up of a resin, and has a volume nearly equal to an ear canal of the user. The microphone 92 has a structure which can be attached to the tube 91. The sound absorbing member 93 is disposed near the center in the tube 91 where air vibrates most largely, so as to suppress the influence of standing waves.

A PC 9 outputs measurement audio data to an output terminal to which the earphone 16 is connected, and acquires measurement data, while attaching the earphone 16 to be measured to the jig 90. As the measurement audio signal, various signals such as white noise, pink noise, and a TSP signal, which allow to measure frequency characteristics, can be applied. The measurement data acquired in this way includes characteristics obtained by excluding a resonance generated in the ear canal from those to be listened to in practice.

Hence, a common measurement system using the jig 90 acquires the frequency characteristics of a high-quality earphone, and those of the earphone used by the user. Then, by designing an equalizer which equalizes the frequency characteristics of the earphone used by the user to those of the high-quality earphone when the user uses the earphone, sound quality of the earphone used by the user can be equalized to that of the high-quality earphone. FIG. 5 is an exemplary graph showing an example of measurement data acquired at this time.

In FIG. 5, “a1” represents measurement data of the earphone 16 to be measured. Also, “a2” represents measurement data of the high-quality earphone as a correction goal. Then, “a3” represents difference data by giving an offset to a difference between these two measurement data. The PC 9 can equalize the sound quality of the earphone used by the user to that of the high-quality earphone using an equalizer having characteristics that match a curve of the difference data a3. However, this method requires the jig 90, thus causing an increase in cost.

On the basis of this measurement principle of the frequency characteristics of the earphone using the jig, a method of measuring the frequency characteristics of the earphone without using any jig will be described below.

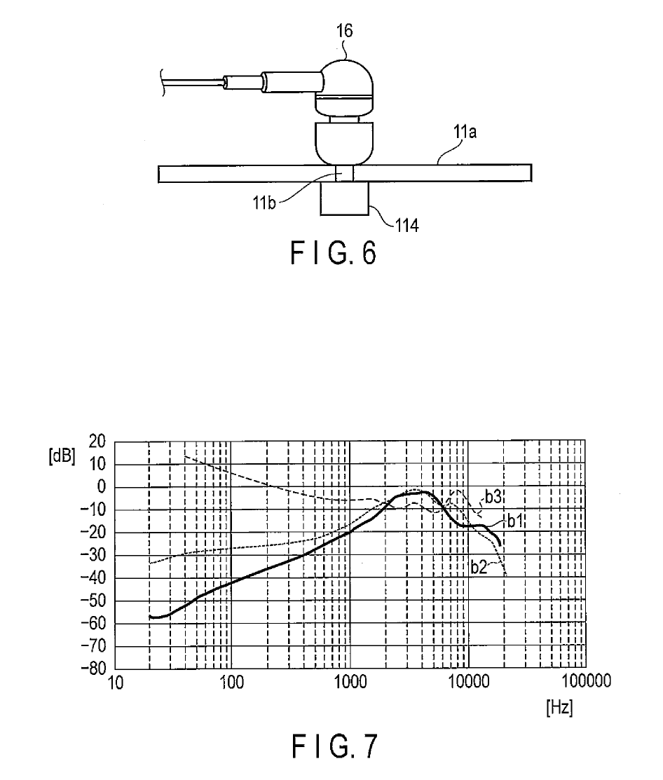

FIG. 6 is an exemplary view showing a state in which an ear tip of the earphone 16 is in tight contact with the microphone 114.

As shown in FIG. 6, the microphone 114 is located on the inner wall of the housing (cabinet 11a) of the computer body 11. As described above, a sound collection opening (microphone aperture 11b) for the microphone 114 is formed in the housing front surface portion of the computer body 11. In this case, upon measuring the frequency characteristics of the earphone 16, the user brings an ear tip of the earphone 16 into tight contact with the microphone aperture 11b.

In this state, when a measurement audio signal is output to the output terminal 113, sound output from the earphone 16 is collected by the microphone 114, thus acquiring measurement data associated with the earphone 16. FIG. 7 is an exemplary graph showing an example of the measurement data acquired at this time.

In FIG. 7, “b1” represents the measurement data of the earphone 16 to be measured. Also, “b2” represents measurement data of a high-sound-quality earphone as a correction goal. Then, “b3” represents difference data obtained by giving an offset to a difference between these two measurement data.

Upon comparison between the difference data a3 shown in FIG. 5 and the difference data b3 shown in FIG. 7, they roughly have similar patterns in a frequency range less than or equal to about 1 kHz, but they have different patterns in a frequency range greater than or equal to about 1 kHz. The frequency range of about 1 kHz will be referred to as a so-called crossover frequency range where a bass range is switched to a treble range hereinafter.

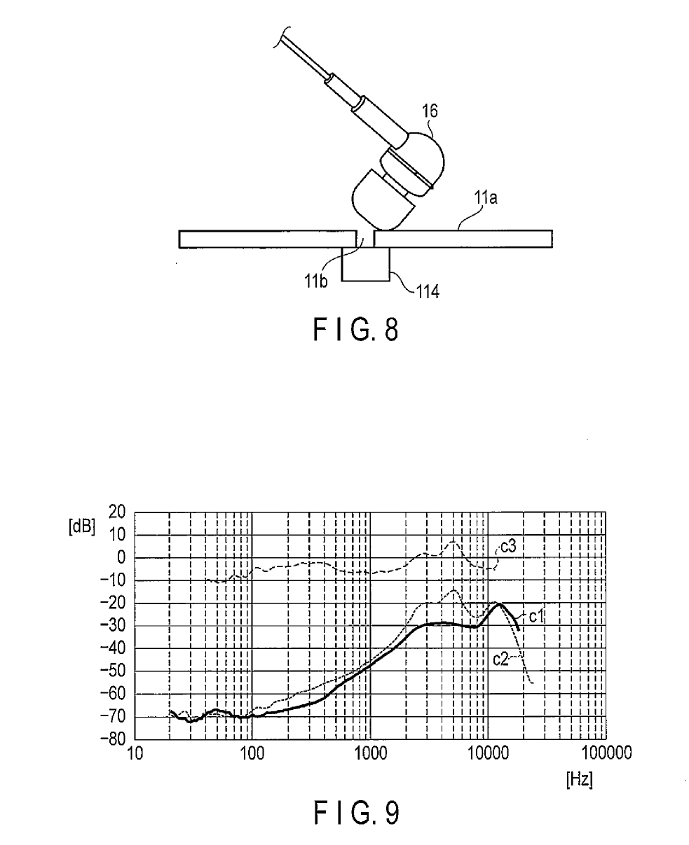

On the other hand, FIG. 8 is an exemplary view showing a state in which a gap is formed between the ear tip of the earphone 16 and the microphone 114. In this case, upon measuring the frequency characteristics of the earphone 16, the user brings the ear tip of the earphone 16 into contact with the housing (cabinet 11a) of the computer body at a tilt. A difference from the state shown in FIG. 6 is that a gap is formed between the earphone 16 and microphone 114. FIG. 9 is an exemplary graph showing an example of measurement data acquired at this time.

In FIG. 9, “c1” represents the measurement data of the earphone 16 to be measured. Also, “c2” represents measurement data of a high-sound-quality earphone as a correction goal. Then, “c3” represents difference data obtained by giving an offset to a difference between these two measurement data.

The measurement data acquired in the state shown in FIG. 8 suffers a considerable attenuation in the low-frequency range. Upon comparison between the difference data a3 shown in FIG. 5 and the difference data c3 shown in FIG. 9, they have different patterns in the frequency range less than or equal to about 1 kHz, but they have similar patterns in the frequency range greater than or equal to about 1 kHz.

That is, as can be seen from the above description, without using any jig, an equalizer can be designed using the measurement data acquired in the state shown in FIG. 6 for the frequency range less than or equal to about 1 kHz, and can be designed using the measurement data acquired in the state shown in FIG. 8 for the frequency range greater than or equal to about 1 kHz.

Hence, for example, the PC 1 of this embodiment acquires the measurement data only once in the state shown in FIG. 8, and corrects the frequency characteristics of the earphone 16 (those of sound output from the earphone 16). A frequency range which can be corrected using this measurement data is that greater than or equal to about 1 kHz, that is, the crossover frequency range or higher, and a treble range can be improved to obtain an effect of, for example, obtaining clearer sound. In this manner, the characteristics of the earphone 16 can be corrected at low cost and by a simple operation. Note that the crossover frequency range is about 1 kHz, as described above, but it may vary depending on conditions of the earphone 16 and microphone 114. Hence, it is certain and easy to empirically acquire this value in a measurement system.

Also, this method can cope with physical restrictions (for example, the microphone surface is a curved surface, and the earphone 16 cannot be in tight contact with the microphone 114).

Conversely, for example, the measurement data may be acquired only once in the state shown in FIG. 6 to correct the frequency characteristics of the earphone 16. A frequency band which can be corrected using this measurement data is that less than or equal to about 1 kHz, that is, the crossover frequency range or lower. In the case of the earphone 16 which is weak in a bass range, sound quality can be remarkably improved by correcting only the bass range. Hence, in this case as well, the characteristics of the earphone 16 can be corrected at low cost and by a simple operation.

For example, when the measurement data is acquired in the state shown in FIG. 8, a correction equalizer is designed for the frequency range greater than or equal to the crossover frequency range. On the other hand, for example, when the measurement data is acquired in the state shown in FIG. 6, a correction equalizer is designed for the frequency range less than or equal to the crossover frequency range. Hence, in these cases, either a frequency band lower or higher than the crossover frequency range does not undergo any correction.

Normally, as a feature of an audio device such as an earphone or microphone, its frequency characteristics basically moderately vary. Hence, when a frequency range greater than or equal to the crossover frequency range is selected as a correction target (when the measurement data is acquired in the state shown in FIG. 8), the PC 1 of this embodiment predicts a correction amount in the frequency range lower than the crossover frequency range based on a difference between the measurement characteristics and goal characteristics in the crossover frequency range, and reflects that amount to the design of an equalizer.

On the other hand, when the frequency range less than or equal to the crossover frequency range is selected as a correction target (when the measurement data is acquired in the state shown in FIG. 6), the PC 1 of this embodiment predicts a correction amount in the frequency range higher than the crossover frequency range based on a difference between the measurement characteristics and target characteristics in the crossover frequency range, and reflects that amount to the design of an equalizer.

In other words, the PC 1 of this embodiment sets a predicted equalizer at a boundary between the frequency range as a correction target (which can be corrected using the measurement data) and that as a non-correction target. For example, using a filter which has a central frequency in the crossover frequency range, and attenuates moderately toward the frequency range as the non-correction target, correction errors of the frequency range as the non-correction target can be eliminated.

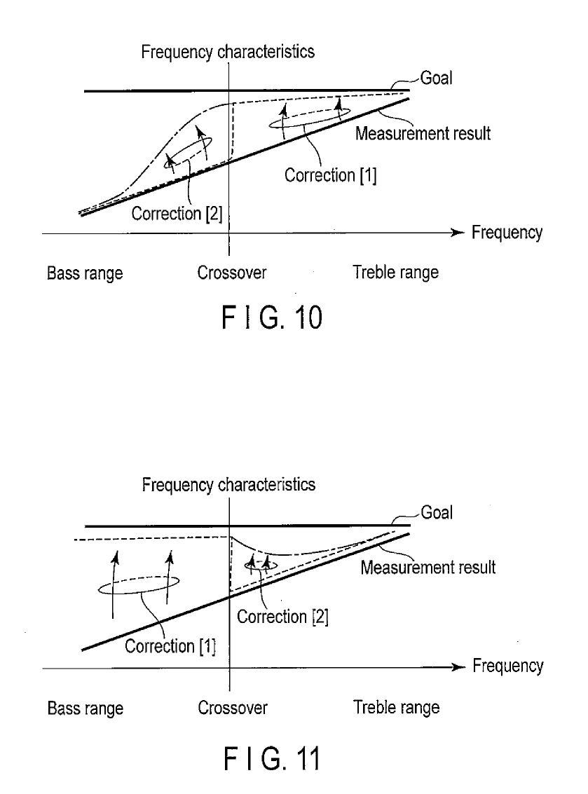

FIG. 10 is an exemplary graph showing the correction procedures of the frequency characteristics of the earphone when the frequency range greater than or equal to the crossover frequency range is selected as a correction target (when the measurement data is acquired in the state shown in FIG. 8). In this case, (1) an equalizer is designed by generating difference data from the measurement data for the frequency range greater than or equal to the crossover frequency range (correction [1]), and (2) an equalizer is designed by prediction based on the measurement data in the crossover frequency range for the frequency range less than or equal to the crossover frequency range (correction [2]).

FIG. 11 is an exemplary graph showing the correction procedures of the frequency characteristics of the earphone when the frequency range less than or equal to the crossover frequency range is selected as a correction target (when the measurement data is acquired in the state shown in FIG. 6). In this case, (1) an equalizer is designed by generating difference data from the measurement data for the frequency range less than or equal to the crossover frequency range (correction [1]), and (2) an equalizer is designed by prediction based on the measurement data in the crossover frequency range for the frequency range greater than or equal to the crossover frequency range (correction [2]).

Referring again to FIG. 3, the operations of the respective modules of the media player 122 will be described below.

The measurement module 211 of the signal measurement module 210 measures the characteristics of the earphone 16 by the aforementioned method. The correction filter design module 212 designs the correction filter 221 (generates coefficients to be applied to the correction filter 221), which serves as an equalizer of the correction/playback module 220, so as to equalize the characteristics of the earphone 16 to goal characteristics generated by the goal characteristic generation module 213.

As the correction filter 221, for example, a general parametric equalizer or the like is effectively used. As the goal characteristic generation method, various methods are applicable. For example, the frequency characteristics of a reference high-sound-quality earphone, which are prepared in advance, may be used intact, or the prepared characteristics may be modified to user's favorite characteristics when they are used. Also, in another method, a plurality of ideal characteristics may be prepared, and the user may select favorite characteristics.

On the other hand, the correction/playback module 220 corrects and outputs sound played back by the audio signal playback module 222 using the correction filter 221 which uses the coefficients generated by the correction filter design module 212 of the signal measurement module 210 in this way. When the user listens to this sound via the earphone 16 used in the measurement, it sounds like that approximate to sound of an ideal earphone. For example, when a music piece is to be played back, the user can enjoy that music with high sound quality.

As described above, according to the PC 1 of this embodiment, the frequency characteristics of the earphone 16 can be appropriately corrected by acquiring the measurement data only once in the state shown in FIG. 8 or FIG. 6 without using any jig. That is, the characteristics of the earphone can be corrected at low cost and by a simple operation.

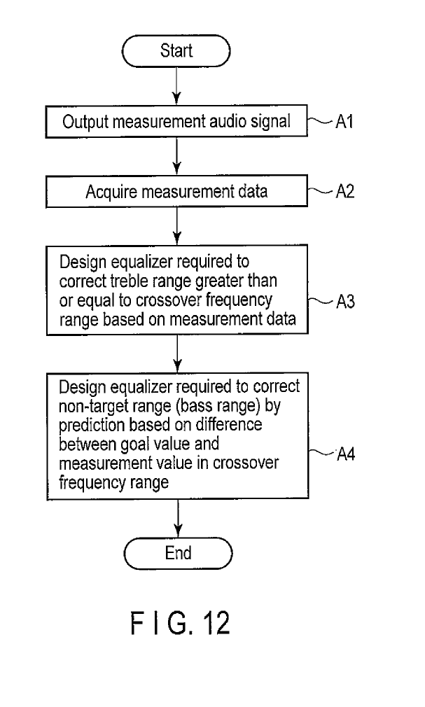

FIG. 12 is an exemplary flowchart showing the sequence of audio signal processing to be executed by the PC 1 to correct the frequency characteristics of the earphone.

The following description will be given under the assumption that the frequency range greater than or equal to the crossover frequency range is selected as a main correction target (when the measurement data is acquired in the state shown in FIG. 8).

The measurement module 211 outputs a measurement audio signal to the output terminal 113 (block A1), and acquires measurement data by collecting the measurement audio signal via the microphone 114 (block A2).

The correction filter design module 212 designs an equalizer required to correct a treble range greater than or equal to the crossover frequency range based on the measurement data acquired by the measurement module 211 (block A3). At the same time, the correction filter design module 212 designs an equalizer required to correct a non-target range (bass range) by prediction based on a difference between the goal value and measurement value in the crossover frequency range (block A4).

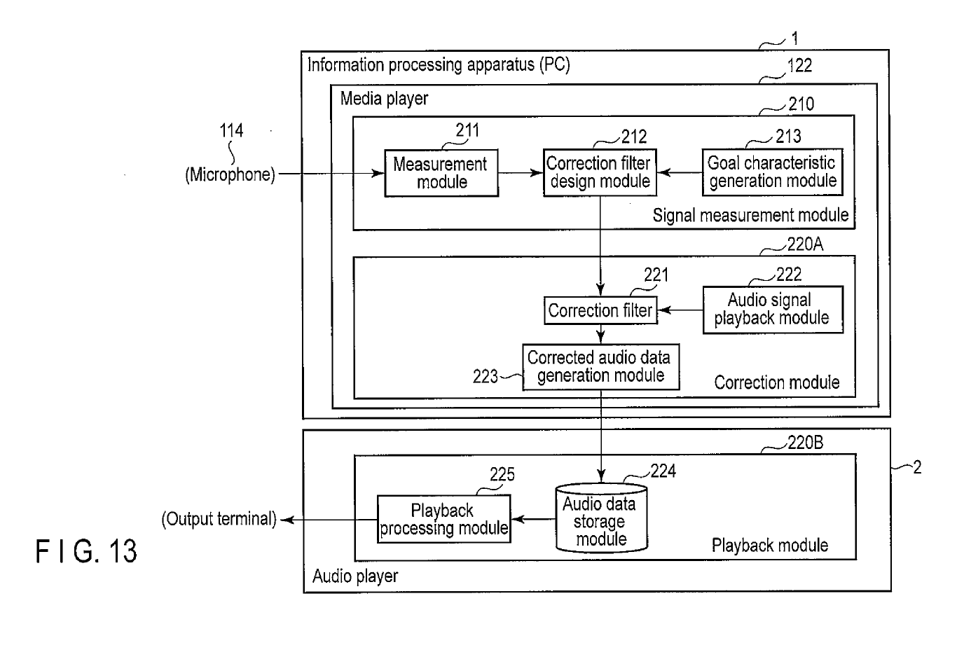

FIG. 13 is an exemplary block diagram for explaining an application example of the audio signal processing to be executed by the PC 1 of this embodiment to correct the frequency characteristics of the earphone.

In the example to be described below, this embodiment allows the user to obtain the aforementioned correction effect when he or she listens to music using the earphone 16, even in a device such as a portable audio player (audio player 2), which cannot include any arbitrary correction filter.

In this case, the correction/playback module 220 of the media player 122 shown in FIG. 3 is divided into a correction module 220A and playback module 220B, and the playback module 220B is installed in the audio player 2 side which is externally connected to the PC 1.

In the aforementioned example, sound played back by the audio signal playback module 222 is corrected using the correction filter 221 (to which the coefficients generated by the correction filter design module 212 of the signal measurement module 210 are applied), and the corrected audio signal is output from the output terminal 113. By contrast, in the application example shown in FIG. 13, an audio signal corrected using the correction filter 221 is supplied to a corrected audio data generation module 223.

The corrected audio data generation module 223 generates corrected audio data by encoding the supplied audio signal, and stores the generated corrected audio data in an audio data storage module 224 of the audio player 2. Then, a playback processing module 225 of the playback module 220B installed in the audio player 2 plays back the corrected audio data stored in the audio data storage module 224, thus outputting it from an output terminal.

That is, since the corrected data is transferred to the playback module 220B, the device (audio player 2) which cannot apply arbitrary correction can obtain the correction effect at a playback timing.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus comprising:
an output terminal configured to output an audio signal;
a microphone;
a measurement module configured to measure frequency characteristics of an earphone based on a measurement audio signal output from an output terminal connected to the earphone, the measurement audio signal collected by the microphone; and
a correction filter design module configured to design a correction filter based on the frequency characteristics of the earphone measured by the measurement module and goal frequency characteristics, the correction filter designed to correct frequency characteristics of sound output from the earphone to the goal frequency characteristics in association with one range of a treble range higher than a crossover frequency range and a bass range lower than the crossover frequency range, the crossover frequency range comprising a frequency range where a bass range is switched to the treble range.

2. The apparatus of claim 1, wherein the correction filter design module is further configured to predict a difference between the frequency characteristics of the earphone and the goal frequency characteristics in association with the one range of the treble range higher than the crossover frequency range and the bass range lower than the crossover frequency range based on a difference between the frequency characteristics of the earphone measured by the measurement module and the goal frequency characteristics in the crossover frequency range, and to design the correction filter to apply correction using the predicted difference as a correction amount.

3. The apparatus of claim 1, wherein the measurement audio signal is collected in a state in which the earphone is in contact with the microphone to form a gap between the earphone and the microphone, when the frequency characteristics of the earphone are corrected to have the treble range higher than the crossover frequency range as a target.

4. The apparatus of claim 1, wherein the measurement audio signal is collected in a state in which the earphone is in tight contact with the microphone, when the frequency characteristics of the earphone are corrected to have the bass range lower than the crossover frequency range as a target.

5. The apparatus of claim 1, further comprising a corrected audio data generation module configured to generate corrected audio data by applying correction using the correction filter to an audio signal and by re-encoding the corrected audio signal, the audio signal obtained by playing back audio data obtained by encoding the audio signal.

6. A method of processing audio signal for an information processing apparatus, the method comprising:
measuring frequency characteristics of an earphone based on a measurement audio signal output from an output terminal used to output an audio signal, the output terminal connected to the earphone, and the measurement audio signal collected by a microphone; and
designing a correction filter based on the measured frequency characteristics of the earphone and goal frequency characteristics, the correction filter designed to correct frequency characteristics of sound output from the earphone to the goal frequency characteristics in association with one range of a treble range higher than a crossover frequency range and a bass range lower than the crossover frequency range, the crossover frequency range being a frequency range where a bass range is switched to the treble range.

7. The method of claim 6, wherein designing the correction filter comprises predicting a difference between the frequency characteristics of the earphone and the goal frequency characteristics in association with the one range of the treble range higher than the crossover frequency range and the bass range lower than the crossover frequency range based on a difference between the measured frequency characteristics of the earphone and the goal frequency characteristics in the crossover frequency range, and designing the correction filter to apply correction using the predicted difference as a correction amount.

8. The method of claim 6, wherein the measurement audio signal is collected in a state in which the earphone is in contact with the microphone to form a gap between the earphone and the microphone, when the frequency characteristics of the earphone are corrected to have the treble range higher than the crossover frequency range as a target.

9. The method of claim 6, wherein the measurement audio signal is collected in a state in which the earphone is in tight contact with the microphone, when the frequency characteristics of the earphone are corrected to have the bass range lower than the crossover frequency range as a target.

10. The method of claim 6, further comprising generating corrected audio data by applying correction using the correction filter to an audio signal and by re-encoding the corrected audio signal, the audio signal obtained by playing back audio data obtained by encoding the audio signal.
